(19) United States
(12) Patent Application Publication
(10) Pub. No.: US 2023/0297457 A1
(43) Pub. Date: Sep. 21, 2023

(54) DIAGNOSTIC METHODS AND SYSTEMS FOR MOBILE ELECTRONIC DEVICES

(71) Applicant: BLANCCO TECHNOLOGY GROUP IP OY, Joensuu (FI)

(72) Inventors: Rahul BAJI, Maharashtra (IN); Sourabh SODANI, Maharashtra (IN); Richa GINDODIA, Maharashtra (IN); Amol MATKAR, Maharashtra (IN); Kundan KALE, Maharashtra (IN)

(21) Appl. No.: 18/020,400

(22) PCT Filed: Aug. 11, 2020
(86) PCT No.: PCT/EP2020/072553

§ 371 Date: Feb. 8, 2023

(51) Int. Cl. G06F 11/07

(52) U.S. Cl. CPC G06F 11/0787; G06F 11/0742

(57) ABSTRACT

A mobile electronic device comprises an operating system and a method for use in providing system-level diagnostic information relating to the performance of hardware of the mobile electronic device comprises receiving a request from a user of the mobile electronic device to execute a diagnostics application on the mobile electronic device and executing the diagnostics application on the mobile electronic device based on user privileges in response to the received user request. Executing the diagnostics application causes the mobile electronic device to invite the user to confirm whether the operating system should generate a bug report and the operating system to generate a bug report at the mobile electronic device in response to the user confirming that the bug report should be generated. The method further comprises extracting the system-level diagnostic information from the bug report at the mobile electronic device and/or at a server located remotely from the mobile electronic device and making the extracted system-level diagnostic information accessible to a third party located remotely from the mobile electronic device and from the server. The method may allow a third party to remotely access the system-level diagnostics information indirectly, for example from a server located remotely from the mobile electronic device. Further, such a method enables system-level information to be obtained from the bug report based only on read-only user privileges.

### FIELD

The present disclosure relates to a method, system, diagnostics application and mobile electronic device for use in providing system-level diagnostic information relating to the performance of hardware of the mobile electronic device and, in particular, though not exclusively, for use in providing system-level diagnostic information relating to the performance of hardware of a mobile electronic device which comprises or runs an Android operating system.

### BACKGROUND

It is common for telecom operators or retailers to offer mobile electronic devices which comprise, or which run, an Android operating system as part of a telecom services plan, such as “AT&T Next”. Under such a telecom services plan, the Android device is leased by the telecom operator or retailer to the end-customer. Telecom operators or retailers may be subsequently required to manage the return and/or upgrade of the Android device. It is in the interests of the telecom operator or retailer to manage the return/upgrade of the Android device efficiently. When an end-consumer wishes to return/upgrade the Android device, the telecom operator or retailer needs to verify the condition of the Android device being returned. For example, it is known for a telecom operator or a retailer to verify the condition of the Android device by connecting the Android device to a PC or a tablet using a USB cable and using a diagnostics solution running on the PC or tablet to obtain “live” access to system-level information on the Android device. However, such methods require not only a wired connection, but also another device such as a PC or a tablet to access the system-level information on the Android device. Consequently, accessing system-level information on an Android device using such a known method requires the telecom operator or retailer to make a substantial investment in hardware and time to achieve the “verification” outcome. Accessing system-level information on an Android device using such a known method is also inconvenient for the end-customer because the end-customer is required to visit a store of the telecom operator or retailer to allow the telecom operator or retailer to verify the condition of the mobile electronic device.

It is also known to provide means for a user of a mobile electronic device to report bugs in a third party application installed on the mobile electronic device to a developer of the third party application. For example, an Android operating system (OS) may provide such functionality through a “take bug report” feature.

### SUMMARY

It should be understood that any one or more of the features of any one of the following aspects may be combined with any one or more of the features of any of the other following aspects.

According to at least one aspect of the present disclosure there is provided a method for use in providing system-level diagnostic information relating to the performance of hardware of a mobile electronic device, the mobile electronic device comprising an operating system, and the method comprising:
receiving a request from a user of the mobile electronic device to execute a diagnostics application on the mobile electronic device;
executing the diagnostics application on the mobile electronic device based on user privileges in response to the received user request thereby causing:
   the mobile electronic device to invite the user to confirm whether the operating system should generate a bug report; and
   the operating system to generate a bug report at the mobile electronic device in response to the user confirming that the bug report should be generated, and the method further comprising:
extracting the system-level diagnostic information from the bug report at the mobile electronic device and/or at a server located remotely from the mobile electronic device; and
making the extracted system-level diagnostic information accessible to a third party located remotely from the mobile electronic device and from the server.

The method for use in providing system-level diagnostic information relating to the performance of hardware of the mobile electronic device may allow a remote third party such as a remote telecom operator, a remote retailer, or a remote original equipment manufacturer (OEM) of the mobile electronic device to remotely access the system-level diagnostics information indirectly, for example from a server located remotely from the mobile electronic device, whilst still allowing the remote third party to perform the same degree of system-level diagnostics on the hardware of the mobile electronic device that is possible using the known methods of performing system-level diagnostics which require the mobile electronic device either to be connected to a PC or tablet using a USB cable.

The method may comprise taking one or more actions based at least in part on the extracted system-level diagnostic information relating to the performance of the hardware of the mobile electronic device. Such a method may allow a remote third party such as a remote telecom operator, a remote retailer or a remote OEM of the mobile electronic device to take one or more actions depending on the system-level performance of the hardware of the mobile electronic device. Such a method may not only be technically more efficient than connecting the mobile electronic device to a PC or tablet using a USB cable, but it may also be more cost-effective for the third party because the third party is not required to operate stores, operate PCs or tablets, and/or to employ people to perform such connections. Such a method may also be more convenient for the end-customer because the end-customer is no longer required to visit a store belonging to the third party when returning the mobile electronic device to the third party.

Further, such a method may enable system-level information to be obtained from the bug report based only on read-only user privileges. Such a method does not require a third party diagnostics application to request or obtain system privileges from the user of the mobile electronic device so as to make system-level information directly accessible via native application specific interfaces (APIs) which would risk the third party diagnostics application being able to not only read, but also to change system-level information or settings, thereby posing a security risk. This may be advantageous because a third party application that requests system privileges from the user may be considered malware due to the associated information security risks with the result that such a third party application would not be accepted for offer or sale on official online sales channels, such as Google Play store.

Further, such a method may not only be more secure than running a third party application that requests system privileges from the user, but it may also allow a third party diagnostics application to be developed that is accepted for offer or sale on official online sales channels whilst still having access to the system-level diagnostics information, because the third party diagnostics application may operate only on user privileges thereby providing access to system-level diagnostics information on a read-only basis. In particular, the third party diagnostics application may operate only on user privileges thereby providing access to system-level diagnostics information indirectly via a server located remotely from the mobile electronic device.

The system-level diagnostic information may comprise information relating to the historical performance of the hardware of the mobile electronic device.

The method may comprise remotely assessing the performance of the hardware of the mobile electronic device based at least in part on the system-level diagnostic information relating to the performance of hardware of the mobile electronic device.

The method may comprise taking one or more actions based at least in part on the performance of the hardware of the mobile electronic device.

Such a method may allow a remote third party such as a remote telecom operator, a remote retailer, or a remote OEM of the mobile electronic device to remotely assess the performance of the hardware of the mobile electronic device and, optionally, to take one or more actions depending on the performance of the hardware of the mobile electronic device e.g. to replace the mobile electronic device. Such a method may allow an OEM of the mobile electronic device to remotely assess the performance of the hardware of the mobile electronic device and, optionally, to replace underperforming component and/or to make changes or improvements to the design of future mobile electronic devices.

The system-level diagnostic information may comprise information relating to the performance of a battery of the mobile electronic device. For example, the system-level diagnostic information may comprise information relating to at least one of the number, frequency, date, time, charging current, and charging duration of charging events of the battery of the mobile electronic device.

The method may comprise remotely assessing the performance of the battery of the mobile electronic device.

The method may comprise taking one or more actions based at least in part on the performance of the battery of the mobile electronic device.

The method may comprise replacing the mobile electronic device and/or replacing the battery of the mobile electronic device based at least in part on the performance of the battery of the mobile electronic device.

Such a method may allow a remote third party such as a remote telecom operator, a remote retailer, or a remote OEM of the mobile electronic device to remotely assess the performance of the battery of the mobile electronic device and, optionally, to take one or more actions depending on the performance of the battery of the mobile electronic device e.g. to replace the mobile electronic device and/or to replace the battery of the mobile electronic device.

The method may comprise making changes or improvements to the design of at least one of future mobile electronic devices, batteries of future mobile electronic devices and battery chargers for future mobile electronic devices based at least in part on the performance of the battery of the mobile electronic device.

Such a method may allow a remote OEM of the mobile electronic device to remotely assess the performance of the battery of the mobile electronic device and, optionally, to make changes or improvements to the design of at least one of future mobile electronic devices, batteries of future mobile electronic devices, and battery chargers for future mobile electronic devices. For example, such a method may allow an OEM to optimize battery charging such that the charging current is optimized according to an expected or typical charging time. Embodiments according to this example provide the advantage that battery-straining high charging currents are used only when charging time is expectedly or typically short.

The system-level diagnostic information may comprise information relating to a temperature of the mobile electronic device. For example, the system-level diagnostic information may comprise information relating to a temperature of the battery of the mobile electronic device.

The method may comprise remotely assessing the temperature performance of the battery of the mobile electronic device.

The method may comprise taking one or more actions based at least in part on the temperature performance of the battery of the mobile electronic device.

The method may comprise replacing the mobile electronic device and/or replacing the battery of the mobile electronic device based at least in part on the temperature performance of the battery of the mobile electronic device.

Such a method may allow a remote third party such as a remote telecom operator or a remote retailer to remotely assess the performance of the mobile electronic device and, optionally, to take one or more actions depending on the performance of the mobile electronic device e.g. to replace the mobile electronic device and/or to replace the battery of the mobile electronic device. Such a method may allow a remote OEM of the mobile electronic device to remotely assess the performance of the mobile electronic device and, optionally, to make changes or improvements to the design of future mobile electronic devices and/or batteries of future mobile electronic devices. For example, such a method may allow a remote OEM to remotely identify one or more of the device models that exhibit the highest battery temperature and, consequently, focus improvement efforts on these device models.

The system-level diagnostic information may comprise information relating to energy and/or power consumption of the mobile electronic device.

The method may comprise remotely assessing the energy and/or power consumption of the mobile electronic device.

The method may comprise taking one or more actions based at least in part on the energy and/or power consumption of the mobile electronic device.

The method may comprise replacing the mobile electronic device and/or replacing the battery of the mobile electronic device based at least in part on the energy and/or power consumption of the mobile electronic device.

Such a method may allow a remote third party such as a remote telecom operator or a remote retailer to remotely assess the performance of the mobile electronic device and, optionally, to take one or more actions depending on the performance of the mobile electronic device e.g. to replace the mobile electronic device and/or to replace the battery or other components of the mobile electronic device. Such a method may allow a remote OEM of the mobile electronic device to remotely assess the performance of the mobile electronic device and, optionally, to make changes or improvements to the design of at least one of future mobile electronic devices, batteries of future mobile electronic devices, and power consuming components of future mobile electronic devices. For example, such a method may allow a remote OEM to remotely identify one or more of the most power consuming components and, consequently, focus improvement efforts and/or component replacements on these components.

The system-level diagnostic information may comprise information relating to one or more power cycles of the mobile electronic device. For example, the system-level diagnostic information may comprise information relating to at least one of the number, frequency, date and time of any power shut downs of the mobile electronic device.

The method may comprise remotely assessing the one or more power cycles of the mobile electronic device.

The method may comprise taking one or more actions based at least in part on the one or more power cycles of the mobile electronic device.

The method may comprise replacing the mobile electronic device and/or replacing the battery of the mobile electronic device based at least in part on the one or more power cycles of the mobile electronic device.

Such a method may allow a remote third party such as a remote telecom operator or a remote retailer to remotely assess the performance of the mobile electronic device and, optionally, to take one or more actions depending on the performance of the mobile electronic device e.g. to replace the mobile electronic device and/or to replace the battery of the mobile electronic device. Such a method may allow a remote OEM of the mobile electronic device to remotely assess the performance of the mobile electronic device and, optionally, to make changes or improvements to the design of future mobile electronic devices and/or batteries of future mobile electronic devices. For example, such a method may allow a remote OEM to improve the stability of future mobile electronic devices in terms of frequency of required power shut downs.

The mobile electronic device may comprise or run an Android operating system such as Android Marshmallow Versions 6.0-6.0.1, Android Nougat Versions 7.0-7.1.2, Android Oreo Versions 8.0-8.1 or Android P Version 9.

The mobile electronic device may comprise a phone or a tablet.

The method may comprise extracting the system-level diagnostic information from a diagnostic output for system services component of the bug report.

The method may comprise extracting the system-level diagnostic information from a “dumpsys” component of the bug report.

The method may comprise extracting at least part of the system-level diagnostic information from the bug report at the server.

The method may comprise transmitting or uploading at least part of the bug report from the mobile electronic device to the server. For example, the method may comprise wirelessly transmitting or uploading at least part of the bug report from the mobile electronic device to the server.

Transmitting or uploading at least part of the bug report from the mobile electronic device to the server and extracting at least part of the system-level diagnostic information from the bug report at the server may reduce the computational burden on the mobile electronic device thereby allowing the mobile electronic device to perform other operations.

The method may comprise transmitting or downloading at least part of the extracted system-level diagnostic information from the server to the mobile electronic device. For example, the method may comprise wirelessly transmitting or downloading at least part of the extracted system-level diagnostic information from the server to the mobile electronic device.

The method may comprise extracting at least part of the system-level diagnostic information from the bug report at the mobile electronic device.

The method may comprise transmitting or uploading at least part of the extracted system-level diagnostic information from the mobile electronic device to the server. For example, the method may comprise wirelessly transmitting or uploading at least part of the extracted system-level diagnostic information from the mobile electronic device to the server.

The bug report may contain a large quantity of data or have a large file size. The system-level diagnostic information extracted from the bug report may include less data or have a smaller file size than the bug report. Consequently, extracting at least part of the system-level diagnostic information at the mobile electronic device and transmitting or uploading at least part of the extracted system-level diagnostic information from the mobile electronic device to the server may reduce the amount of data that needs to be transmitted or uploaded from the mobile electronic device to the server.

The method may comprise filtering, anonymizing, re-formatting and/or encrypting at least part of the system-level diagnostic information at the mobile electronic device prior to transmitting or uploading the information to the server. As an example, the method may comprise filtering out any personally identifiable information (PII) from the report. The method may comprise anonymizing any PII in order to comply with any data protection regulation, such as the GDPR. As another example, the method may comprise re-formatting the system-level diagnostic information to a proprietary file type. The method may comprise encrypting the system-level diagnostic information with a proprietary encryption key in order to avoid any information security risks posed by unauthorized parties intercepting the transmission or gaining access to the server.

The method may comprise:
transmitting or uploading the bug report from the mobile electronic device to the server and extracted the system-level diagnostic information from the bug report at the server; or
extracting the system-level diagnostic information at the mobile electronic device and transmitting or uploading the extracted system-level diagnostic information from the mobile electronic device to the server,
according to the speed at which data may be transmitted from the mobile electronic device to the server and/or according to the available computational resources or available computational capacity of the mobile electronic device and the server.

Such a method may minimise the time taken to extract the system-level diagnostic information from the bug report according to the speed at which data may be transmitted from the mobile electronic device to the server and/or according to the available computational resources or available computational capacity of the mobile electronic device and the server.

The method may comprise distributing the computational operations required to extract the system-level diagnostic information from the bug report between the mobile electronic device and the server and transmitting or uploading part of the bug report from the mobile electronic device to the server according to the speed at which data may be transmitted from the mobile electronic device to the server and/or according to the available computational resources or available computational capacity of the mobile electronic device and the server. Such a method may minimise the time taken to extracted the system-level diagnostic information from the bug report according to the speed at which data may be transmitted from the mobile electronic device to the server and/or according to the available computational resources or available computational capacity of the mobile electronic device and the server.

The method may comprise storing the extracted system-level diagnostic information at the mobile electronic device and/or at the server.

The method may comprise displaying the extracted system-level diagnostic information on the mobile electronic device. Such a method may allow a user of the mobile electronic device to review the extracted system-level diagnostic information and, optionally, to take one or more actions in response to the extracted system level diagnostic information.

The method may comprise generating the bug report in response to a request from the user of the mobile electronic device.

The method may comprise making the extracted system-level diagnostic information accessible to the remote third party in response to a request from the user of the mobile electronic device.

The method may comprise making the extracted system-level diagnostic information accessible to the user of the mobile electronic device in response to a request from the user of the mobile electronic device.

The method may comprise receiving a request from the user of the mobile electronic device to download the diagnostics application from an online sales channel to the mobile electronic device and to install the diagnostics application on the mobile electronic device.

The method may comprise receiving a request from the user of the mobile electronic device to execute a diagnostics application on the mobile electronic device.

The method may comprise executing the diagnostics application on the mobile electronic device in response to the received user request to execute the diagnostics application.

Executing the diagnostics application may cause the mobile electronic device to:
notify the user when the bug report has been generated; and
invite the user to confirm whether the bug report should be shared with the diagnostics application.

The method may comprise providing the diagnostics application with permission and/or privileges to access the bug report in response to the user confirming that the bug report should be shared with the diagnostics application.

Inviting the user of the mobile electronic device to confirm whether the bug report should be generated may comprise:
directing the user to a take bug report option in a device setting menu of the mobile electronic device; and
inviting the user to confirm, using the take bug report option in the device setting menu, whether the bug report should be generated.

In response to the user confirming that the bug report should be shared with the diagnostics application, the diagnostics application may cause the mobile electronic device to transmit or upload, for example wirelessly transmit or upload, at least part of the bug report from the mobile electronic device to the server for extraction of the system-level diagnostic information from the bug report at the server.

In response to the user confirming that the bug report should be shared with the diagnostics application, the diagnostics application may cause the mobile electronic device to:
generate at least part of the system-level diagnostic information at the mobile electronic device; and
transmit or upload, for example wirelessly transmit or upload, at least part of the generated system-level diagnostic information from the mobile electronic device to the server.

The method may comprise:
repeatedly generating bug reports at the mobile electronic device; and
repeatedly extracting system-level diagnostic information from the bug reports.

The method may comprise repeatedly storing the extracted system-level diagnostic information at the mobile electronic device and/or at the server.

The method may comprise refreshing and/or over-writing system-level diagnostic information relating to the performance of the mobile electronic device which was previously stored at the mobile electronic device and/or at the server.

According to at least one aspect of the present disclosure there is provided a method for use in providing system-level diagnostic information relating to the performance of a mobile electronic device, the method comprising:
generating a bug report at the mobile electronic device;
extracting the system-level diagnostic information from the bug report at the mobile electronic device and/or at a server located remotely from the mobile electronic device; and
making the extracted system-level diagnostic information accessible to a third party located remotely from the mobile electronic device and from the server.

According to at least one aspect of the present disclosure there is provided a system for use in providing system-level diagnostic information relating to the performance of hardware of a mobile electronic device, the mobile electronic device comprising an operating system, and the system comprising:
the mobile electronic device; and
a server located remotely from the mobile electronic device,
wherein the mobile electronic device is configured to receive a request from a user of the mobile electronic device to execute a diagnostics application on the mobile electronic device and to execute the diagnostics application on the mobile electronic device based on user privileges in response to the received user request thereby causing the mobile electronic device to invite the user to confirm whether the operating system should generate a bug report, and the operating system to generate a bug report at the mobile electronic device in response to the user confirming that the bug report should be generated,
wherein at least one of the mobile electronic device and the server is configured to extract the system-level diagnostic information from the bug report, and
wherein the server is configured to make the extracted system-level diagnostic information accessible to a third party located remotely from the mobile electronic device and from the server.

The mobile electronic device may be configured to make the extracted system-level diagnostic information accessible to a user of the mobile electronic device.

According to at least one aspect of the present disclosure there is provided a system for use in providing system-level diagnostic information relating to the performance of a mobile electronic device, the system comprising:
the mobile electronic device; and
a server located remotely from the mobile electronic device,
wherein the mobile electronic device is configured to generate a bug report,
wherein at least one of the mobile electronic device and the server is configured to extract the system-level diagnostic information from the bug report, and
wherein the server is configured to make the extracted system-level diagnostic information accessible to a third party located remotely from the mobile electronic device and from the server.

According to at least one aspect of the present disclosure there is provided a diagnostics application for use in providing system-level diagnostic information relating to the performance of hardware of a mobile electronic device, wherein, the diagnostics application is executable by a processor of the mobile electronic device to cause the mobile electronic device to initiate any of the methods described above.

According to at least one aspect of the present disclosure there is provided a mobile electronic device comprising a diagnostics application as described above.

It should be understood that any one or more of the features of any one of the foregoing aspects may be combined with any one or more of the features of any of the other foregoing aspects.

### BRIEF DESCRIPTION OF THE DRAWINGS

A method, system, diagnostics application, and mobile electronic device for use in providing system-level diagnostic information relating to the performance of hardware of the mobile electronic device will now be described by way of non-limiting example only with reference to the following drawings of which:

FIG. 1 is a schematic of a mobile electronic device and a system for use in providing system-level diagnostic information relating to the performance of hardware of the mobile electronic device;

FIG. 2 is a flow chart illustrating a method for use in providing system-level diagnostic information relating to the performance of the hardware of the mobile electronic device;

FIG. 3A is a screenshot of an Apps menu in a display of the mobile electronic device;

FIG. 3B is a screenshot of a Developer Options menu in the display of the mobile electronic device;

FIG. 3C is a screenshot of a Take Bug Report options menu in the display of the mobile electronic device;

FIG. 3D is a screenshot of a notifications page in the display of the mobile electronic device indicating that a bug report is being generated;

FIG. 3E is a screenshot of the notifications page in the display of the mobile electronic device indicating that a bug report has been generated;

FIG. 3F is a screenshot of a permissions page in the display of the mobile electronic device requesting permission to share a bug report with a SmartChk diagnostics application;

FIG. 3G is a screenshot of a holding page in the display of the mobile electronic device indicating that the bug report is being uploaded from the mobile electronic device to a server located remotely from the mobile electronic device; and

FIG. 3H is a screenshot of a diagnostics results page in the display of the mobile electronic device.

### DETAILED DESCRIPTION OF THE DRAWINGS

One of ordinary skill in the art will understand that one or more of the features of the embodiments described below with reference to the drawings may produce effects or provide advantages when used in isolation from one or more of the other features of the embodiments and that different combinations of the features are possible other than the specific combinations of the features of the embodiments described below.

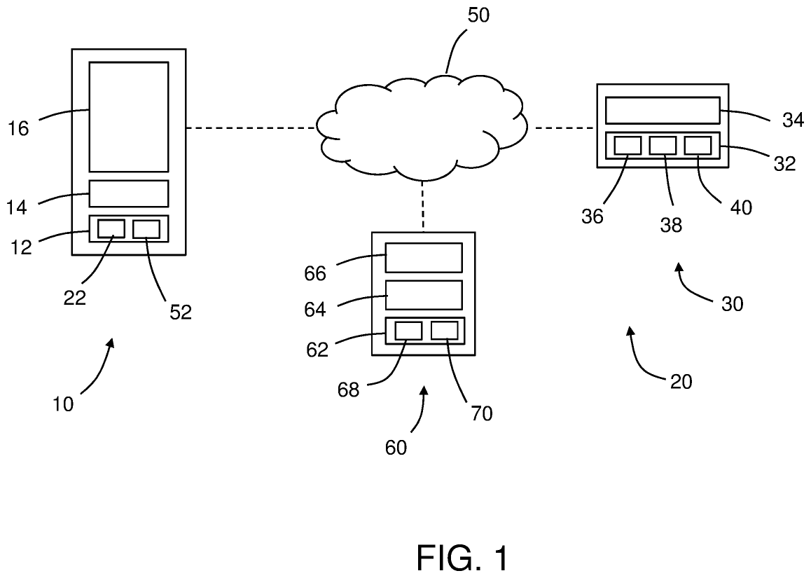

Referring initially to FIG. 1 there is shown a mobile electronic device in the form of an Android device generally designated 10 and a system, generally designated 20, for use in providing system-level diagnostic information relating to the performance of hardware of the Android device 10. The Android device 10 includes a memory 12, a processor 14, and a touchscreen 16.

The system 20 includes a diagnostics application 22 stored in the memory 12 of the Android device 10. The system 20 further includes a server, generally designated 30, which is located remotely from the Android device 10. The server 30 includes a memory 32, and a processor 34. The memory 32 stores a program 36, a bug report 38 relating to the performance of the Android device 10, and system-level diagnostic information 40 relating to the performance of the hardware of the Android device 10.

As shown in FIG. 1, the Android device 10 and the server 30 are configured for wireless communication via the cloud 50.

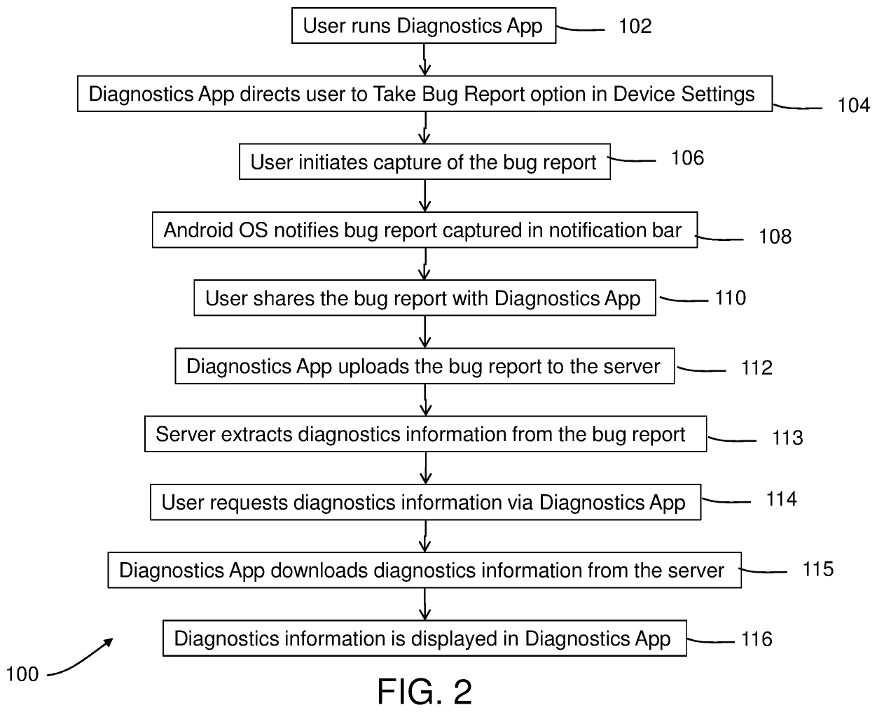

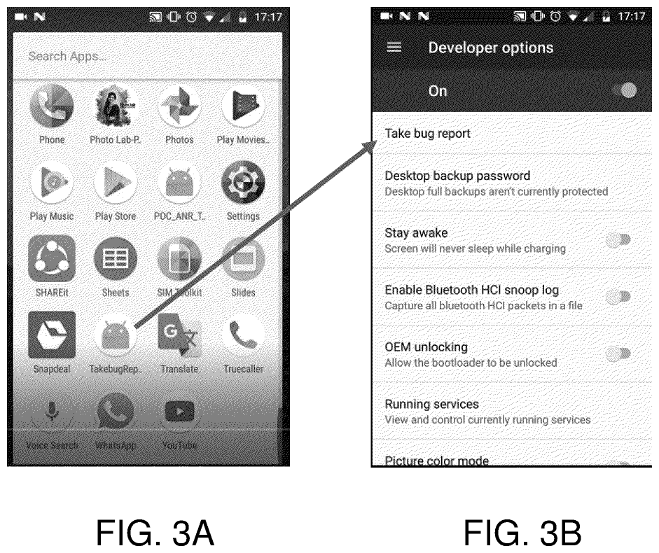

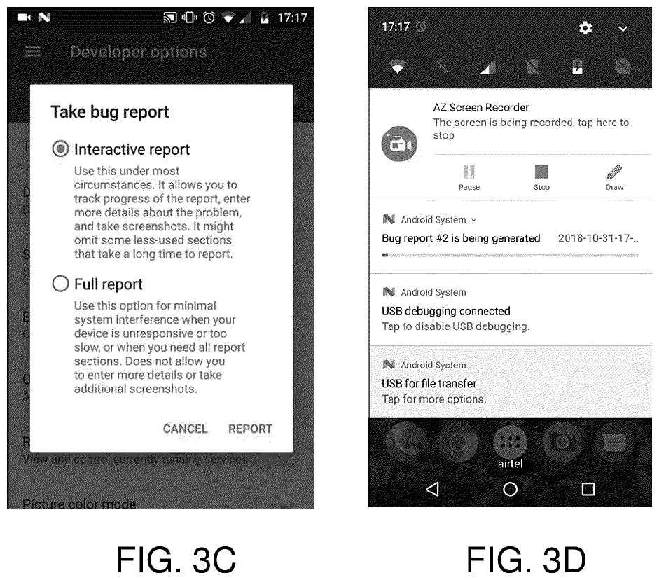

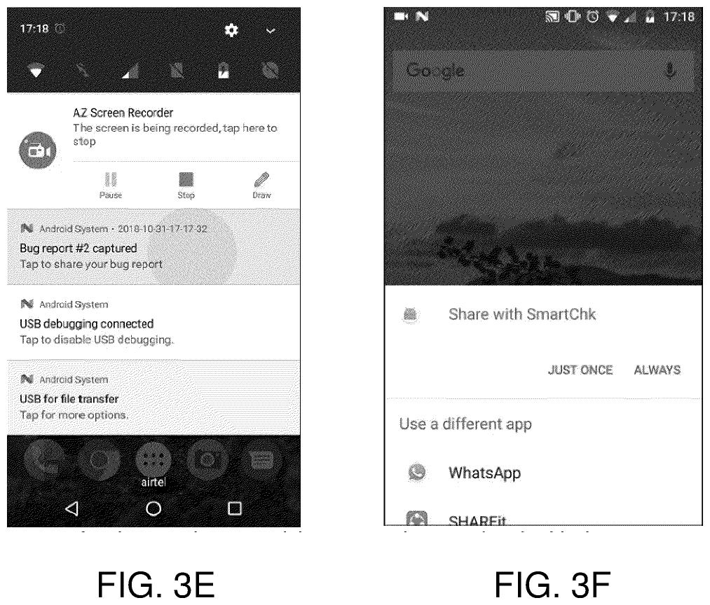

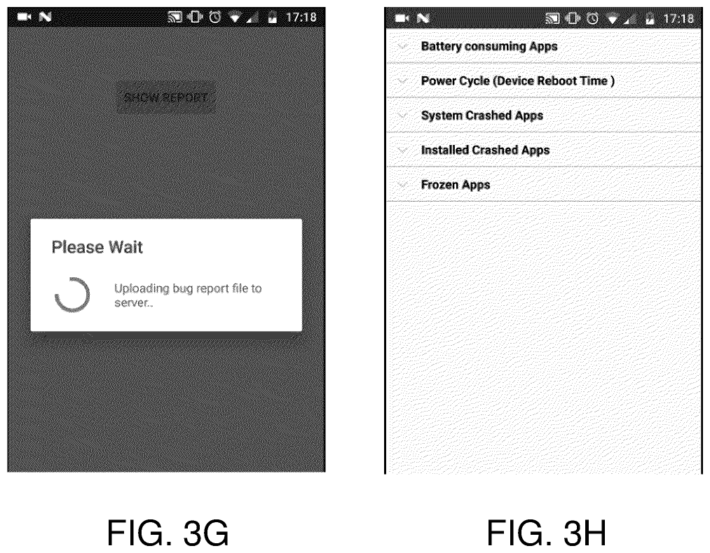

The diagnostics application 22 may be executed by the processor 14 of the Android device 10 to initiate the method which is illustrated in FIG. 2 and which is generally designated 100 for use in providing the system-level diagnostic information 40 relating to the performance of the hardware of the Android device 10. The method 100 is further described in detail below with reference to the screenshots of FIGS. 3A-3H.

The method 100 begins at step 102 with the Android device 10 receiving a user request to run the diagnostics application 22. On execution of the diagnostics application 22 at step 104 of the method 100, the diagnostics application 22 directs the user to a “Take Bug Report” option in the “Device Settings” menu of the Android device 10 shown in FIG. 3A and the “Take Bug Report” option in the “Developer options” menu shown in FIG. 3B. At step 106 of the method 100, the Android device 10 receives a request to capture a bug report. As shown in FIG. 3C, the request to capture a bug report may require the user to select an “interactive report” option or a “full report” option and to select a “REPORT” icon on the touchscreen 16 of the Android device 10. The Android device 10 then notifies the user that the bug report is being generated as shown in FIG. 3D. At step 108 of the method 100, the Android device 10 notifies the user once the bug report has been captured as shown in FIG. 3E. At step 110 of the method 100 and, as shown in FIG. 3F, the Android device 10 invites or prompts the user to share the bug report with the diagnostics application 22 by selecting a “Share with SmartChk” icon on the touchscreen 16 of the Android device 10. At step 112 of the method 100, the diagnostics application 22 uploads the bug report via the cloud 50 to the memory 32 of the server 30 where the bug report is saved as the stored bug report 38. Specifically, the diagnostics application 22 uploads the bug report as a .zip file to the server 30 where the bug report is unzipped and saved as the stored bug report 38 in the memory 32 of the server 30.

In response to receiving the bug report 38, the method 100 continues at step 113 with the processor 34 of the server 30 executing the program 36 to thereby extract the system-level diagnostic information 40 relating to the performance of the hardware of the Android device 10 from the bug report 38. Specifically, when executed by the processor 34, the program 36 causes the processor 34 to identify the diagnostic output for system services (dumpsys) component of the bug report 38 and to extract the system-level diagnostic information 40 relating to the performance of the hardware of the Android device 10 from the data of the dumpsys component. The processor 34 stores the extracted system-level diagnostic information 40 as a file in the memory 32 of the server 30. As will be described in more detail below, the stored system-level diagnostic information 40 is accessible to a user of the Android device 10 and/or to one or more third parties such as telecom operators, retailers and/or application developers.

At step 114 of the method 100, the Android device 10 may receive a user request for system-level diagnostic information via the diagnostics application 22. In response to receiving the user request for the system-level diagnostic information, the method may continue at step 115 with the diagnostics application 22 downloading at least part of the system-level diagnostic information 40 from the server 30 to the Android device 10 and saving at least part of the system-level diagnostic information in the memory 12 of the Android device 10 as stored system-level diagnostic information 52. Specifically, the diagnostics application 22 transmits a processing command to the processor 34 of the server 30 via the cloud 50. The processor 34 applies the processing command to the file containing the system-level diagnostic information 40 stored in the memory 32 of the server 30 causing at least part of the system-level diagnostic information 40 to be fetched, downloaded or otherwise transmitted from the server 30 to the Android device 10, where at least part of the system-level diagnostic information 40 is saved in the memory 12 of the Android device 10 as the stored system-level diagnostic information 52.

The method 100 may then continue at step 116 with the diagnostics application 22 displaying a system-level diagnostic information menu on the touchscreen 16 of the Android device 10 as shown in FIG. 3H. In response to receiving a user selection of one or more system-level diagnostic parameters via the touchscreen 16 of the Android device 10, the diagnostics application 22 may display the one or more system-level diagnostic parameters of interest on the touchscreen 16 of the Android device 10.

It will be appreciated by one of ordinary skill in the art that various modifications may be made to the foregoing system and method without departing from the scope of the present invention as defined by the claims. For example, as an alternative to, or in addition to, performing steps 114, 115 and 116 of the method 100, a third party such as a telecom operator, a retailer or an OEM of the Android device 10 may request access to at least some of the system-level diagnostic information 40 stored in the memory 32 of the server 30 using a further device such as a PC 60 shown in FIG. 1 via the cloud 50. For example, the PC 60 may include a memory 62, a processor 64 and a user interface 66. The PC 60 may further include a program 68 which, when executed by the processor 64, allows the third party to request access to at least some of the system-level diagnostic information 40 stored in the memory 32 of the server 30 via the cloud 50. Specifically, in response to receiving a request for system-level diagnostic information from the third party via the user interface 66, the PC 60 may download the system-level diagnostic information 40 from the server 30 to the PC 60 and save the system-level diagnostic information in the memory 62 of the PC 60 as stored system-level diagnostic information 70. The method may then continue with the user interface 66 displaying a system-level diagnostic information menu like the system-level diagnostic information menu of the Android device 10 shown in FIG. 3H. In response to receiving a selection of one or more system-level diagnostic parameters via the user interface 66 of the PC 60, the program 68 may display the one or more system-level diagnostic parameters of interest to the telecom operator or retailer or the third party via the user interface 66 of the PC 60.

The method may comprise:
transmitting or uploading the bug report from the mobile electronic device to the server and extracting the system-level diagnostic information from the bug report at the server; or
extracting the system-level diagnostic information from the bug report at the mobile electronic device and transmitting or uploading the generated system-level diagnostic information from the mobile electronic device to the server,
according to the speed at which data may be transmitted from the mobile electronic device to the server and/or according to the available computational resources or available computational capacity of the mobile electronic device and the server.

Such a method may minimise the time taken to extract the system-level diagnostic information from the bug report according to the speed at which data may be transmitted from the mobile electronic device to the server and/or according to the available computational resources or available computational capacity of the mobile electronic device and the server.

The method may comprise distributing the computational operations required to extract the system-level diagnostic information from the bug report between the mobile electronic device and the server and transmitting or uploading part of the bug report from the mobile electronic device to the server according to the speed at which data may be transmitted from the mobile electronic device to the server and/or according to the available computational resources or available computational capacity of the mobile electronic device and the server. Such a method may minimise the time taken to extract the system-level diagnostic information from the bug report according to the speed at which data may be transmitted from the mobile electronic device to the server and/or according to the available computational resources or available computational capacity of the mobile electronic device and the server.

One of ordinary skill in the art should understand that the system-level diagnostic information may comprise information relating to the historical performance of hardware of the mobile electronic device.

The system-level diagnostic information may comprise information relating to the performance of a battery of the mobile electronic device, for example information relating to at least one of the number, frequency, date, time, charging current, and charging duration of charging events of the battery of the mobile electronic device.

The system-level diagnostic information may comprise information relating to a temperature of the mobile electronic device, for example information relating to a temperature of the battery of the mobile electronic device.

The system-level diagnostic information may comprise information relating to energy and/or power consumption of the mobile electronic device.

The system-level diagnostic information may comprise information relating to one or more power cycles of the mobile electronic device, for example information relating to at least one of the number, frequency, date and time of any power shut downs of the mobile electronic device.

The mobile electronic device may comprise or run an Android operating system such as Android Marshmallow Versions 6.0-6.0.1, Android Nougat Versions 7.0-7.1.2, Android Oreo Versions 8.0-8.1 or Android P Version 9.

The mobile electronic device may comprise a phone or a tablet.

1. A method for use in providing system-level diagnostic information relating to the performance of hardware of a mobile electronic device, the mobile electronic device comprising an operating system, and the method comprising:
receiving a request from a user of the mobile electronic device to execute a diagnostics application on the mobile electronic device;
executing the diagnostics application on the mobile electronic device based on user privileges in response to the received user request thereby causing:
the mobile electronic device to invite the user to confirm whether the operating system should generate a bug report; and
the operating system to generate a bug report at the mobile electronic device in response to the user confirming that the bug report should be generated; and the method further comprising:
extracting the system-level diagnostic information from the bug report at the mobile electronic device and/or at a server located remotely from the mobile electronic device; and
making the extracted system-level diagnostic information accessible to a third party located remotely from the mobile electronic device and from the server.

2. The method as claimed in claim 1, further comprising extracting the system-level diagnostic information from a diagnostic output for system services component of the bug report.

3. The method as claimed in claim 1, further comprising transmitting or uploading, for example wirelessly transmitting or uploading, at least part of the bug report from the mobile electronic device to the server.

4. The method as claimed in claim 1, further comprising transmitting or downloading, for example wirelessly transmitting or downloading, at least part of the system-level diagnostic information from the server to the mobile electronic device.

5. The method as claimed in claim 1, further comprising transmitting or uploading, for example wirelessly transmitting or uploading, at least part of the system-level diagnostic information from the mobile electronic device to the server.

6. The method as claimed in claim 1, further comprising storing the extracted system-level diagnostic information at the mobile electronic device and/or at the server.

7. The method as claimed in claim 1, further comprising making the extracted system-level diagnostic information accessible to a user of the mobile electronic device

8. The method as claimed in claim 1, further comprising displaying the extracted system-level diagnostic information on the mobile electronic device.

9. The method as claimed in claim 1, further comprising making the extracted system-level diagnostic information accessible to the third party and/or to the user of the mobile electronic device in response to a request from the user of the mobile electronic device.

10. The method as claimed in claim 1, wherein inviting the user of the mobile electronic device to confirm whether the bug report should be generated comprises:
directing the user to a take bug report option in a device setting menu of the mobile electronic device; and
inviting the user to confirm, using the take bug report option in the device setting menu, whether the bug report should be generated.

11. The method as claimed in claim 1, wherein executing the diagnostics application causes the mobile electronic device to:
notify the user when the bug report has been generated; and
invite the user to confirm whether the bug report should be shared with the diagnostics application.

12. The method as claimed in claim 11, further comprising providing the diagnostics application with permission and/or privileges to access the bug report in response to the user confirming that the bug report should be shared with the diagnostics application.

13. The method as claimed in claim 11, wherein, in response to the user confirming that the bug report should be shared with the diagnostics application, the diagnostics application causes the mobile electronic device to transmit or upload, for example wirelessly transmit or upload, at least part of the bug report from the mobile electronic device to a server for extraction of the system-level diagnostic information from the bug report at the server.

14. The method as claimed in claims 11, wherein, in response to the user confirming that the bug report should be shared with the diagnostics application, the diagnostics application causes the mobile electronic device to:
generate at least part of the system-level diagnostic information at the mobile electronic device; and
transmit or upload, for example wirelessly transmit or upload, at least part of the generated system-level diagnostic information from the mobile electronic device to a server.

15. The method as claimed in claim 1, further comprising:
repeatedly generating bug reports at the mobile electronic device; and
repeatedly extracting system-level diagnostic information from the bug reports.

16. The method as claimed in claim 15, further comprising repeatedly storing the extracted system-level diagnostic information at the mobile electronic device and/or at the server.

17. The method as claimed in claim 16, further comprising refreshing and/or over-writing system-level diagnostic information relating to the performance of the mobile electronic device which was previously stored at the mobile electronic device and/or at the server.

18. A system for use in providing system-level diagnostic information relating to the performance of hardware of a mobile electronic device, the mobile electronic device comprising an operating system, and the system comprising:
the mobile electronic device; and
a server located remotely from the mobile electronic device,
wherein the mobile electronic device is configured to receive a request from a user of the mobile electronic device to execute a diagnostics application on the mobile electronic device and to execute the diagnostics application on the mobile electronic device based on user privileges in response to the received user request thereby causing the mobile electronic device to invite the user to confirm whether the operating system should generate a bug report and the operating system to generate a bug report at the mobile electronic device in response to the user confirming that the bug report should be generated,
wherein at least one of the mobile electronic device and the server is configured to extract the system-level diagnostic information from the bug report, and
wherein the server is configured to make the extracted system-level diagnostic information accessible to a third party located remotely from the mobile electronic device and from the server.

19. The system as claimed in claim 18, wherein the mobile electronic device is configured to make the extracted system-level diagnostic information accessible to a user of the mobile electronic device.

20. A diagnostics application for use in providing system-level diagnostic information relating to the performance of hardware of a mobile electronic device, wherein, the diagnostics application is executable by a processor of the mobile electronic device to cause the mobile electronic device to initiate the method of claim 1.

21. A mobile electronic device comprising the diagnostics application of claim 20.

22. The method, system, diagnostics application or the mobile electronic device as claimed in claim 1, wherein the system-level diagnostic information comprises information relating to the historical performance of hardware of the mobile electronic device.

23. The method, system, diagnostics application or the mobile electronic device as claimed in claim 1, wherein the system-level diagnostic information comprises at least one of:
information relating to the performance of a battery of the mobile electronic device;
information relating to at least one of the number, frequency, date, time, charging current, and charging duration of charging events of the battery of the mobile electronic device;
information relating to a temperature of the mobile electronic device;
information relating to a temperature of a battery of the mobile electronic device;
information relating to energy and/or power consumption of the mobile electronic device;
information relating to one or more power cycles of the mobile electronic device;
information relating to at least one of the number, frequency, date and time of any power shut downs of the mobile electronic device.

24. The method, system, diagnostics application or the mobile electronic device as claimed in claim 1, wherein the mobile electronic device comprises or runs an Android operating system such as Android Marshmallow Versions 6.0-6.0.1, Android Nougat Versions 7.0-7.1.2, Android Oreo Versions 8.0-8.1 or Android P Version 9.
